(19) United States
(12) Patent Application Publication
(10) Pub. No.: US 2022/0101359 A1
(43) Pub. Date: Mar. 31, 2022

(54) SYSTEM AND METHOD FOR AUTOMATED SALES FORECAST ON DEAL LEVEL DURING BLACK SWAN SCENARIO

(71) Applicant: Aviso LTD., Redwood City, CA (US)

(72) Inventors: Joy MUSTAFI, Hyderabad (IN); Sayan Deb KUNDU, Kolkata (IN); Trevor RODRIGUES, Scottsdale, AZ (US)

(73) Assignee: Aviso LTD., Redwood City, CA (US)

(21) Appl. No.: 17/039,690

(22) Filed: Sep. 30, 2020

(51) Int. Cl. G06Q 30/02; G06Q 10/04; G06Q 10/10; G06Q 40/02; G06N 20/00

(52) U.S. Cl. CPC G06Q 30/0206; G06Q 10/04; G06N 20/00; G06Q 30/0205; G06Q 40/025; G06Q 10/10

(57) ABSTRACT

The present invention relates to a method and system for automated sales forecast on a deal level during the black swan scenario. A list of features is being generated that influence the sales forecast on the deal level. The data related to a list of features are processed and transformed into an appropriate form through feature engineering. The artificial intelligence-based model is being selected and trained by the feeding data. The artificial intelligence-based model is optimized with the help of hyper parameter values. The artificial intelligence-based model uses previous data and generates probability scores, forecast close date postponement, and forecast amount on which sale deal would close. Thus, based on the above forecast, overall sales on the deal level are being forecasted. The artificial intelligence-based model is trained and deployed for the sales forecast on the deal level with the help of a computational unit.

### FIELD OF INVENTION

The present invention relates to an artificial intelligence-based system, and method for sales forecast, and more specifically relates to an artificial intelligence-based platform for sales forecast on a deal level for sales representative during the black swan scenario.

The world economy has become very complex nowadays. Even with a slight change in the world economy, the sales of a particular sector of industries get affected. If there is an economic slowdown, then that affects the sales of the particular sector of industries, even a particular company. Thus ultimately sales target of a particular sales representative of a particular company.

Black swan event is one of the factors that affect the economy very badly. Black swan event reduces buyer confidence thereby clouding a range of sales forecasts where once-predictable portions of the business continue to behave differently. Due to black swan event sales drastically get affected. Since black swan events are unpredictable then make it difficult for sales representatives to close the deal.

Though statistics are help full in predicting the overall economy based on the previous data of the black swan event. But there is no such statistics method available for sales representatives to measure sales on the deal level. There is no such statistics method available for a sales representative to check the probability of closing of deal and loss even if the deal gets closed.

Patent application JP2015043167A discloses a PROBLEM TO BE SOLVED: To predict sales easily at low costs. SOLUTION: The sales prediction system is configured so that: an attribute addition part 280 extracts a customer or environment attribute which contributes to sales based on a sales model stored in a sales model DB 270 and then stores the attribute in an attribute by pattern DB 240; a normalization processing part 250 normalizes a sales pattern stored in a sales pattern DB 230; a SOM learning part 260 stores the sales model obtained by executing clustering of the normalized sales pattern in the sales model DB 270; and a collection part 210 collects the pieces of information stored in environment data, customer data, and POS data in accordance with a setting condition preset by a setting DB 220.

The exiting invention does not provide forecasts probability of closing of an anticipated deal amidst the Black Swan scenario and dipping consumer sentiments. The exiting invention does not forecast the probability of closing of deal and loss even if the deal gets closed. This is within the aforementioned context that a need for the present invention has arisen. Thus, there is a need to address one or more of the foregoing disadvantages of conventional systems and methods, and the present invention meets this need.

### SUMMARY OF THE INVENTION

The present invention relates to a method for automated sales forecast on a deal level during the black swan scenario. The method including:

A method of generating an artificial intelligence model, the method having
a list of features is being generated that influence the sales forecast on the deal level;
the data related to a list of features is being gathered from a company server;
further data are processed and transformed into an appropriate form through feature engineering;
based on the requirement of sales forecast on the deal level the artificial intelligence-based model is being selected after the feature engineering has processed the data related to the list of features;
the artificial intelligence-based model is trained by the feeding data that is being processed by feature engineering;
further, the artificial intelligence-based model is optimized with the help of hyper parameter values, to achieve the artificial intelligence-based model's best performance.

In the preferred embodiment, the list of features, that are being utilized to forecast sales of on the deal level, are including, but not limited to, the geography of the accounts bearing the opportunity, sector of the accounts bearing the opportunity, analogous company for the accounts, stage of the opportunity, CRM staleness of the opportunity, temporal data, account economic health, size of the account, relationship history of the account, average sales cycle increase, the credit risk of the account.

A method of analyzing data and forecasting sales on the deal level, the method having
the artificial intelligence-based model uses previous data and generates probability scores on a deal level thus providing the probability of winning a sale deal within a specified time period;
a tree-based artificial intelligence-based model uses previous data and forecast close date postponement of a sale deal;
further, the tree-based artificial intelligence-based model forecast amount on which sale deal would close; and
thus, based on the above forecast, overall sales on the deal level is being forecasted.

Herein, multiple artificial intelligence-based models are trained to forecast different parameters of sales on the deal level.

The main advantage of the present invention is that the present invention provides a forecast on the individual deal of sales representatives.

Yet another advantage of the present invention is that the present invention provides forecasts sales on deal level amidst Black Swan scenario and dipping consumer sentiments.

Yet another advantage of the present invention is that the present invention provides a comprehensive analysis of forecasts from the bottom-up level.

Yet another advantage of the present invention is that the present invention forecast chances of future layoffs or salary cuts.

Yet another advantage of the present invention is that the present invention gives a path-to-plan for the sales representative to meet their quota.

Further objectives, advantages, and features of the present invention will become apparent from the detailed description provided herein below, in which various embodiments of the disclosed invention are illustrated by way of example.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates a flowchart of the method of the present invention.

FIG. 2 illustrates the system of the present invention.

### DETAILED DESCRIPTION OF THE INVENTION

### Definition

The terms “a” or “an”, as used herein, are defined as one or as more than one. The term “plurality”, as used herein, is defined as two as or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”.

Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps, or acts are in some way inherently mutually exclusive.

As used herein, the term “one or more” generally refers to, but not limited to, singular as well as the plural form of the term.

The drawings featured in the figures are to illustrate certain convenient embodiments of the present invention and are not to be considered as a limitation to that. The term “means” preceding a present participle of operation indicates the desired function for which there is one or more embodiments, i.e., one or more methods, devices, or apparatuses for achieving the desired function and that one skilled in the art could select from these or their equivalent because of the disclosure herein and use of the term “means” is not intended to be limiting.

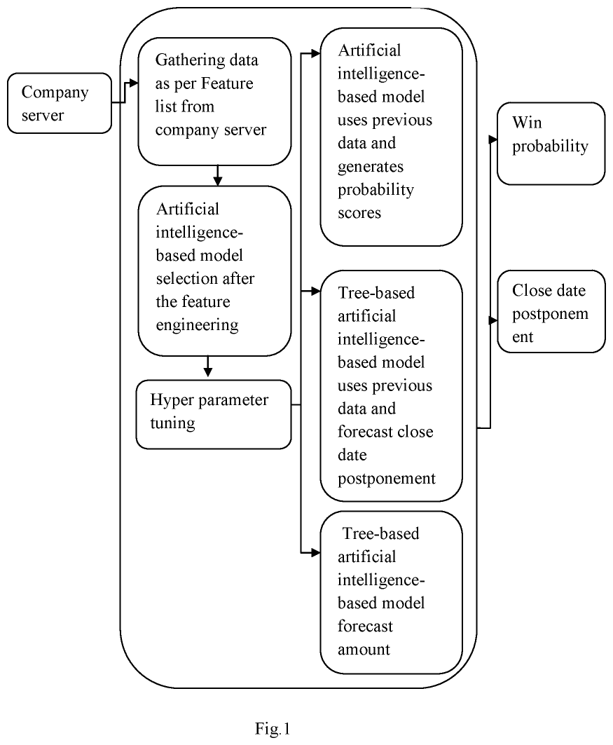

FIG. 1 illustrates a flow chart of method for automated sales forecast on a deal level. A list of features is being generated that influence the sales forecast on the deal level. The data related to a list of features is being gathered from a company server and further data are processed and transformed into an appropriate form through feature engineering. Based on the requirement of sales forecast on the deal level the artificial intelligence-based model is being selected after the feature engineering has processed the data related to a list of features. The artificial intelligence-based model is trained by the feeding data that is being processed by feature engineering and further, the artificial intelligence-based model is optimized with the help of hyper parameter values, to achieve the artificial intelligence-based model's best performance. The artificial intelligence-based model uses previous data and generates probability scores on a deal level thus providing the probability of winning a sale deal within a specified time period. A tree-based artificial intelligence-based model uses previous data and forecast close date postponement of a sale deal. Further, the tree-based artificial intelligence-based model forecast amount on which sale deal would close. Thus, based on the above forecast, win probability for a deal and close date postponement of the deal is being forecasted.

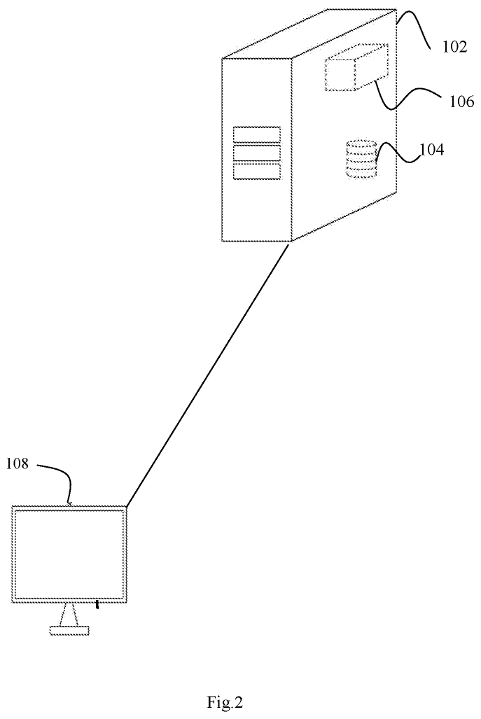

FIG. 2 illustrates a computational unit (102). The computational unit (102) includes a database unit (104), a display unit (108), and a system processing unit (106). The display unit (108) is connected to the system processing unit (106) of the computational unit (102). The system processing unit (106) executes computer-readable instructions to collect the data related to the list of features from the company servers and the system processing unit (106) further executes computer-readable instruction to forecast sales on the deal level during the black swan scenario. The display unit (108) displays the forecast.

The present invention relates to a method for automated sales forecast on a deal level during the black swan scenario. The method including:

A method of generating an artificial intelligence model, the method having
a list of features is being generated that influence the sales forecast on the deal level;
the data related to a list of features is being gathered from a company server;
further data are processed and transformed into an appropriate form through feature engineering;
based on the requirement of sales forecast on the deal level the artificial intelligence-based model is being selected after the feature engineering has processed the data related to a list of features;
the artificial intelligence-based model is trained by the feeding data that is being processed by feature engineering;
further, the artificial intelligence-based model is optimized with the help of hyper parameter values, to achieve the artificial intelligence-based model's best performance.

In the preferred embodiment, the list of features, that are being utilized to forecast sales of on the deal level, are including, but not limited to, the geography of the accounts bearing the opportunity, sector of the accounts bearing the opportunity, analogous company for the accounts, stage of the opportunity, CRM staleness of the opportunity, temporal data, account economic health, size of the account, relationship history of the account, average sales cycle increase, the credit risk of the account.

A method of analyzing data and forecasting sales on the deal level, the method having
the artificial intelligence-based model uses previous data and generates probability scores on a deal level thus providing the probability of winning a sale deal within a specified time period;
a tree-based artificial intelligence-based model uses previous data and forecast close date postponement of a sale deal;
further, the tree-based artificial intelligence-based model forecast amount on which sale deal would close; and
thus, based on the above forecast, overall sales on the deal level is being forecasted.

Herein, multiple artificial intelligence-based models are trained to forecast different parameters of sales on the deal level.

In the preferred embodiment, the artificial intelligence-based model is being used to forecast win probability for a deal and close date postponement of the deal.

In the preferred embodiment, the artificial intelligence-based model to provide a comprehensive analysis of forecasts of sales from the bottom-up level that gives a path-to-plan for the sales representative to meet their quota.

In an embodiment, the artificial intelligence-based model is trained and deployed for the sales forecast on the deal level with the help of a computational unit. The computational unit includes a database unit, a display unit, and a system processing unit. The database unit stores computer-readable instructions and the artificial intelligence-based model. The system processing unit executes computer-readable instructions and inputs various data related to the list of features from the company servers into the artificial intelligence-based model to train the artificial intelligence-based model that further executes bottom-up analysis to forecast sales of on deal level. The display unit is connected to the system processing unit of the computational unit and the display unit displays the sales forecast.

Herein, the system processing unit executes computer-readable instructions to collect the data related to the list of features from the company servers and the system processing unit further executes computer-readable instruction to forecast sales on the deal level during the black swan scenario.

In an embodiment, the computational unit is selected from a desktop computer, a laptop, a tablet, a smartphone, a mobile phone.

In an embodiment, the data related to the list of features that are being collected from the company servers includes a variety of data including, but not limited to, the geography of the accounts bearing the opportunity, sector of the accounts bearing the opportunity, analogous company for the accounts, stage of the opportunity, CRM staleness of the opportunity, temporal data, account economic health, size of the account, relationship history of the account, average sales cycle increase, the credit risk of the account.

In an embodiment, the data related to the list of features helps to train the artificial intelligence-based model that is further being used by the system processing unit to forecast sales of the company on the deal level during the black swan scenario.

In an embodiment, the artificial intelligence-based model is trained and deployed for the sales forecast on the deal level with the help of one or more computational units. The one or more computational units include one or more database units, one or more display units, and a system processing unit. The one or more database units store computer-readable instructions and the artificial intelligence-based model. The system processing unit executes computer-readable instructions and inputs various data related to the list of features from the company servers into the artificial intelligence-based model to train the artificial intelligence-based model that further executes bottom-up analysis to forecast sales of on deal level. The one or more display units are connected to the system processing unit of the one or more computational units and the one or more display units display sales forecast;

Herein, the system processing unit executes computer-readable instructions to collect the data related to the list of features from the company servers and the system processing unit further executes computer-readable instruction to forecast sales on the deal level during the black swan scenario.

In an embodiment, the one or more computational units are including, but not limited to, a desktop computer, a laptop, a tablet, a smartphone, a mobile phone.

In an embodiment, the data related to the list of features that are being collected from the company servers includes a variety of data including, but not limited to, the geography of the accounts bearing the opportunity, sector of the accounts bearing the opportunity, analogous company for the accounts, stage of the opportunity, CRM staleness of the opportunity, temporal data, account economic health, size of the account, relationship history of the account, average sales cycle increase, the credit risk of the account.

Further objectives, advantages, and features of the present invention will become apparent from the detailed description provided herein, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings.

1. A method for automated sales forecast on a deal level during black swan scenario, the method comprising:
a method of generating an artificial intelligence model, the method having
a list of features is being generated that influence the sales forecast on the deal level,
the data related to a list of features is being gathered from a company server;
further data are processed and transformed into an appropriate form through feature engineering,
based on the requirement of sales forecast on the deal level the artificial intelligence-based model is being selected after the feature engineering has processed the data related to a list of features,
the artificial intelligence-based model is trained by the feeding data that is being processed by feature engineering,
further, the artificial intelligence-based model is optimized with the help of hyper parameter values, to achieve the artificial intelligence-based model's best performance,
a method of analyzing data and forecasting sales on the deal level, the method having
the artificial intelligence-based model uses previous data and generates probability scores on a deal level thus providing the probability of winning a sale deal within a specified time period,
a tree-based artificial intelligence-based model uses previous data and forecast close date postponement of a sale deal,
further, the tree-based artificial intelligence-based model forecast amount on which sale deal would close, and
thus based on the above forecast, overall sales on the deal level is being forecasted;
wherein, multiple artificial intelligence-based models are trained to forecast different parameters of sales on the deal level;

2. As claimed in claim 1, wherein, the artificial intelligence-based model is being used to forecast win probability for a deal and close date postponement of the deal.

3. The method as claimed in claim 1, wherein the list of features, that are being utilized to forecast sales of on the deal level, are selected from the geography of the accounts bearing the opportunity, sector of the accounts bearing the opportunity, analogous company for the accounts, stage of the opportunity, CRM staleness of the opportunity, temporal data, account economic health, size of the account, relationship history of the account, average sales cycle increase, the credit risk of the account.

4. The method as claimed in claim 1, wherein the artificial intelligence-based model to provide a comprehensive analysis of forecasts of sales from the bottom-up level that gives a path-to-plan for the sales representative to meet their quota.

5. The method as claimed in claim 1, wherein the artificial intelligence-based model is trained and deployed for sales forecast on the deal level with help of an at least one computational unit, the at least one computational unit comprising:
an at least one database unit, the at least one database unit stores computer-readable instructions and the artificial intelligence-based model, and
a system processing unit, the system processing unit executes computer-readable instructions and inputs various data related to the list of features from the company servers into the artificial intelligence-based model to train the artificial intelligence-based model that further executes bottom-up analysis to forecast sales of on deal level; and
an at least one display unit, the at least one display unit is connected to the system processing unit of the at least one computational unit and the at least one display unit displays sales forecast;
wherein, the system processing unit executes computer-readable instructions to collect the data related to the list of features from the company servers and the system processing unit further executes computer-readable instruction to forecast sales on the deal level during the black swan scenario.

6. The system as claimed in claim 5, wherein the at least one computational unit is selected from a desktop computer, a laptop, a tablet, a smartphone, a mobile phone.

7. The company data as claimed in claim 5, wherein the data related to the list of features that are being collected from the company servers includes a variety of data selected from the geography of the accounts bearing the opportunity, sector of the accounts bearing the opportunity, analogous company for the accounts, stage of the opportunity, CRM staleness of the opportunity, temporal data, account economic health, size of the account, relationship history of the account, average sales cycle increase, the credit risk of the account.

8. The company data as claimed in claim 5, wherein the data related to the list of features helps to train the artificial intelligence-based model that is further being used by the system processing unit to forecast sales of the company on the deal level during the black swan scenario.
